(19) United States
(12) Patent Application Publication
(10) Pub. No.: US 2015/0036526 A1
(43) Pub. Date: Feb. 5, 2015

(54) METHOD AND SYSTEM FOR EFFICIENT TRANSMISSION OF OVER-THE-TOP STREAMS OVER FIXED-LINE NETWORKS

(71) Applicant: imVision Software Technologies Ltd., Ramat Gan (IL)

(72) Inventor: Sharon Mantin, Tel Aviv (IL)

(73) Assignee: imVision Software Technologies Ltd., Ramat Gan (IL)

(21) Appl. No.: 14/446,880

(22) Filed: Jul. 30, 2014

Related U.S. Application Data
(60) Provisional application No. 61/859,833, filed on Jul. 30, 2013.

(51) Int. Cl. H04L 12/18; H04L 12/26

(52) U.S. Cl. CPC H04L 12/1886; H04L 43/08
USPC 370/252; 370/390

(57) ABSTRACT

A method and system for delivery of over-the-top (OTT) streams over a fixed-line network are provided. The method comprises monitoring OTT streams flow in the fixed-line network; determining if the delivery of at least one of the monitored OTT streams improves the efficiency of the fixed-line network when the at least one of the OTT streams is delivered in a multicast format; reformatting the at least one of the OTT streams into a multicast OTT stream; instructing user edge devices connected to the fixed-line network to expect the reception of the multicast OTT stream; and delivering the multicast OTT stream to the user edge devices over the fixed-line network.

### CROSS-REFERENCE TO RELATED APPLICATIONS

This application claims the benefit of U.S. Provisional Application No. 61/859,833 filed on Jul. 30, 2013, the contents of which are hereby incorporated by reference.

### TECHNICAL FIELD

The present invention relates generally to transmission of over-the-top (OTT) and managed content and, more particularly, to efficient transmission of OTT content over fixed-line communication networks.

### BACKGROUND

The world of digital delivery of multimedia content to viewers has been rapidly progressing. Typical types of multimedia content include video clips, electronic games, and interactive content. The delivery process for such multimedia content, particularly those transmitted in a form of video, may entail use of a variety of delivery standards, video quality levels, and other parameters. The techniques used in traditional television (TV) broadcasting cannot be effectively used in the more modern multi-standard digital TV arena. Currently, only piecemeal solutions are available for efficient and seamless delivery of such multimedia content to the arena of digital TV.

Specifically, content delivery is currently performed using two main approaches: legacy content distribution and over-the-top (OTT) content distribution. Legacy content providers include, for example, cable, satellite, and internet protocol TV (IPTV) providers. Typically, such providers have full control over the entire delivery chain from a central location where the content is originated and transmitted (head-end) through the network to the end user's device (e.g., a set-top box). Therefore, legacy content providers can manage and guarantee efficient content delivery mechanisms and high Quality of Experience (QoE) to the end user.

Over-the-top (OTT) content distribution is the delivery of audio, video, and other types of multimedia content over the Internet typically without any control of the content distribution by the network operators and/or by the content providers. The providers of OTT content are typically third party providers which utilize the network's infrastructure to provide content to their subscribers. As such, OTT content providers are not responsible for controlling redistribution of the content. Examples for OTT content providers are Hulu®, Netflix®, and the like.

In most cases, OTT content providers control only the edges of a content distribution network. These edges are typically HTTP media streaming servers connected in the Internet and the media players installed in user devices. The media is streamed from the media servers toward each of the end user's devices as a transmission control protocol (TCP) based unicast stream. Such streams consume network resources (e.g., bandwidth per each content consumer) through the path between the media streaming server and the end user device. This architecture results with a linear growth of network resources where each added consumer increases the consumed network resources. However, as noted above, OTT content providers have no control over the distribution network. Rather, such providers merely utilize the network's infrastructure to deliver content. As such, OTT content providers are not responsible for the overall efficiency of OTT content distribution over the network and, as such, cannot guarantee high QoE to their subscribers.

The popularity of OTT services downgrades the overall performance of the communication networks managed by internet service providers (ISPs), cellular operator, and fix-line operators. Specifically, OTT content delivery significantly increases the bandwidth consumption in such networks. As a result, ISPs and the like cannot ensure high Quality of Service (QoS) to their subscribers, thereby forcing ISPs to upgrade their networks to support the increased demand for bandwidth. In addition, congested networks cause higher packets loss and longer packet delays, thereby downgrading the QoE of OTT streaming services.

Various types of OTT content or streams can be streamed over a network. For example, the type of the streamed content may be live, linear, replicated, or recorded. A live OTT stream is a transmission of a live content (e.g., a sports match, a concert, news, etc.). A linear stream is a broadcasted content, such as a TV show broadcasted over the Internet. In both live and linear OTT streams, all viewers watch the same stream substantially at the same time. In contrast, recorded content such as, e.g., content from a video on demand (VoD) service, may be viewed by different viewers in asynchronous manners, i.e., each user can start watching the recorded content at any time, and the viewing times of users may fully overlap, may partially overlap, or may not overlap at all.

Streamed multimedia (video/audio) content (including OTT content) can be delivered in two forms: managed and unmanaged. The managed content refers to content owned by a network operator that is delivered by the operator or through one of its partners. As such, the network operator controls the media streaming server and, therefore, can determine if the delivered content can be multicasted, as well as the number of concurrent viewers of the streamed content. The unmanaged content (including OTT content) refers to content being delivered transparently over the network. As such, the network operator does not have any information regarding the type of the content being streamed or the number concurrent viewers.

Existing solutions for multicasting multimedia content including OTT streams are discussed in the related art. One approach for reducing the bandwidth consumption of OTT content and services is based on caching the OTT streams' content and generating a signature for a portion of the cached content. The signature is used to determine if the content was previously requested, and, if so, whether the content is being served from the caching server. The drawback of this solution is that it cannot determine if the requested content is live or linear, as the signatures represent only a segment of the content. For example, a signature can be generated for a first segment (e.g., the first 50 KB) of a video, but for continuous live streams that viewers can start watching at any point in time, the first segment may be determined to be a portion of the stream beginning with the point at which the user started viewing rather than the beginning of the entire stream. Hence, signatures generated for a first segment are meaningless.

Another solution discussed in the related art includes generation of managed content and delivery of such content to an end user's set-top box (STB) from the operator. However, the delivery of managed content is limited to cellular networks and IPTV networks. In cellular networks, the managed content is transmitted to user devices (e.g., smartphones, tablet computers, PCs, smart TV, etc.) as a unicast stream. In IPTV networks, the managed content is multicasted or broadcasted to the STBs of end users.

It would therefore be advantageous to provide a solution for efficient delivery of OTT and managed content that would overcome at least the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all embodiments. Its sole purpose is to present some concepts of one or more embodiments in a simplified form as a prelude to the more detailed description that is presented later. For convenience, the term some aspects may be used herein to refer to a single aspect or multiple aspects of the disclosure.

Certain disclosed embodiments include a method for delivery of over-the-top (OTT) streams over a fixed-line network. The method comprises monitoring OTT streams flow in the fixed-line network; determining if the delivery of at least one of the monitored OTT streams improves the efficiency of the fixed-line network when the at least one of the OTT streams is delivered in a multicast format; reformatting the at least one of the OTT streams into a multicast OTT stream; instructing user edge devices connected to the fixed-line network to expect the reception of the multicast OTT stream; and delivering the multicast OTT stream to the user edge devices over the fixed-line network

Certain disclosed embodiments also include a system for a system for delivery of over-the-top (OTT) streams in a fixed-line network. The system comprises a processing unit; and a memory, the memory containing instructions that, when executed by the processing unit, configure the system to: monitor OTT streams flow in the fixed-line network; determine if the delivery of at least one of the monitored OTT streams improves the efficiency of the fixed-line network when the at least one of the OTT streams is delivered in a multicast format; reformat the at least one of OTT streams into a multicast OTT stream; instruct user edge devices connected to the fixed-line network to expect the reception of the multicast OTT stream; and deliver the multicast OTT stream to the user edge devices over the fixed-line network.

Certain disclosed embodiments also include a method for delivery of managed multimedia content in a fixed-line network. The method comprises receiving an indication that a managed content can be delivered in a multicast format; reformatting the managed content from a unicast format to a multicast format; and instructing user edge devices connected to the fixed-line network to expect the reception of the managed content in a multicast format.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram of a content distribution network utilized to describe the various disclosed embodiments.

FIG. 2 is a block diagram of a server for efficient delivery of OTT streams according to one embodiment.

FIG. 3 is a block diagram of a stream detector operable in the server shown in FIG. 2.

FIG. 4 is a block diagram of a multicast stream generator operable in the server shown in FIG. 2.

FIG. 5 is a block diagram of a streaming proxy utilized to describe the various disclosed embodiments.

FIG. 6 is a flowchart showing operation of a method for efficient delivery of OTT streams according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

As an example of the above, in some embodiments, a method and system for efficient delivery of OTT streams in communications networks and, particularly, wireline and/or fixed-line networks, are provided. In an embodiment, unicast OTT streams that flow from and to user edge devices (UEDs) are monitored and analyzed to self-determine if such streams can be multicasted. In an embodiment, the efficiency of delivery of such OTT streams in multicast format is also determined. An OTT stream that is likely to be converted to a multicast format may include, but is not limited to, a live, linear, or replicated OTT, or any other multicast-able streams, where such streams that may be converted to a multicast format are commonly referred to hereinafter as a “multicast-able OTT stream”. A live OTT stream with a high probability of demonstrating improved efficiency when delivered in a multicast format is converted from a unicast to multicast format. In an embodiment, the UED is configured to switch from a source that provides unicast OTT streams to the disclosed system that generates OTT streams in a multicast format. In another embodiment, the system supports the delivery of managed content as multicast streams over the fixed-line network.

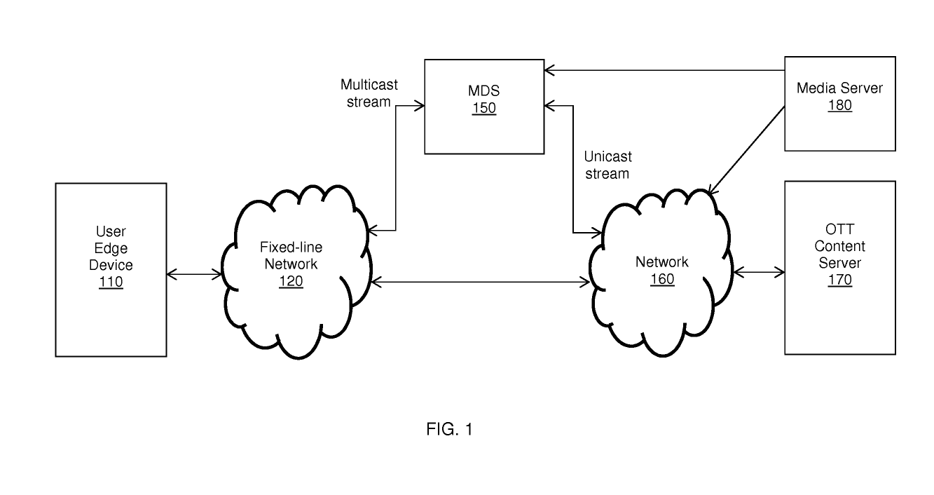

FIG. 1 is an exemplary and non-limiting diagram of a content distribution network utilized to describe the various embodiments disclosed herein. In an exemplary implementation, the network 100 includes a user edge device (UED) 110 configured to play content (e.g., video content) streamed by an OTT content provider from an OTT content server 170. The UED 110 may be, but is not limited to, a PC, a smart phone, an electronic kiosk, a tablet computer, a wearable computing device, a smart TV, and the like. The UED 110 is configured to execute a media-player from any one of a web-browser, an application (e.g., a mobile app), and the like.

The UED 110 is further connected to a fixed-line network 120. In an exemplary embodiment, the fixed-line network 120 may be any broadband network based on infrastructure including, but not limited to, cable, fiber optic, digital subscriber line (DSL), or any other communication network allowing connectivity of end users to the Internet. Typically, such a network includes several network elements including, but not limited to, switches, routers, digital subscriber line access multiplexers (DSLAMs), cable modem termination systems (CMTS), base transceiver stations (BTS), and so on, through which the end user sends and receives data to and from the Internet. The fixed-line network 120 is typically operated by any of an internet service provider (ISP), a telecom network provider, a cable television (TV) provider, and the like. It should be noted that the connectivity of UEDs such as UED 110 to the fixed-line network 120 is typically through a local area network (LAN), a wireless LAN (WLAN), and the like. As a non-limiting example, the UED 110 may be a tablet computer connected through a WLAN to a DSL modem that provides a connection to the DSL access network. The DSL access network is controlled by the ISP.

At the other end of the system, the OTT content server 170 is also communicatively connected to a multicast delivery system (MDS) 150 through a network 160. The network 160 may be a local area network, a wide area network (WAN), a metropolitan area network (MAN), the Internet, and the like. The OTT content server 170 locally hosts or receives the multimedia content from its origin (e.g., a studio, not shown) in real-time. The OTT content server 170 is configured to stream this content as an OTT content stream to the end user over the networks 120 and 160. OTT content servers (e.g., OTT content server 170) are typically deployed in datacenters in different geographical locations. Although not shown in FIG. 1, OTT content servers are typically connected to content distribution networks (CDNs). Also connected to the fixed-line network 120 is a media server 180 that provides managed content. The operator of the network 120 controls the operation of the media server 180.

In an embodiment, the MDS 150 is configured to execute the disclosed embodiments of methods for efficient delivery of OTT streams and, in particular, of multicast-able OTT streams. The operation of the MDS 150 allows reduction of the bandwidth consumption and improves the performance of the fixed-line network 120 when delivering OTT streams to the UEDs. The OTT content server 170 streams unicast OTT streams to UEDs (e.g., the UED 110). The MDS 150 monitors requests from the UED 110 for OTT streams and responses from the OTT content server 170 to determine if such requests and responses are related to multicast-able OTT streams. As noted above, multicast-able OTT streams include live, linear, replicated, duplicated, or other multicast-able OTT streams.

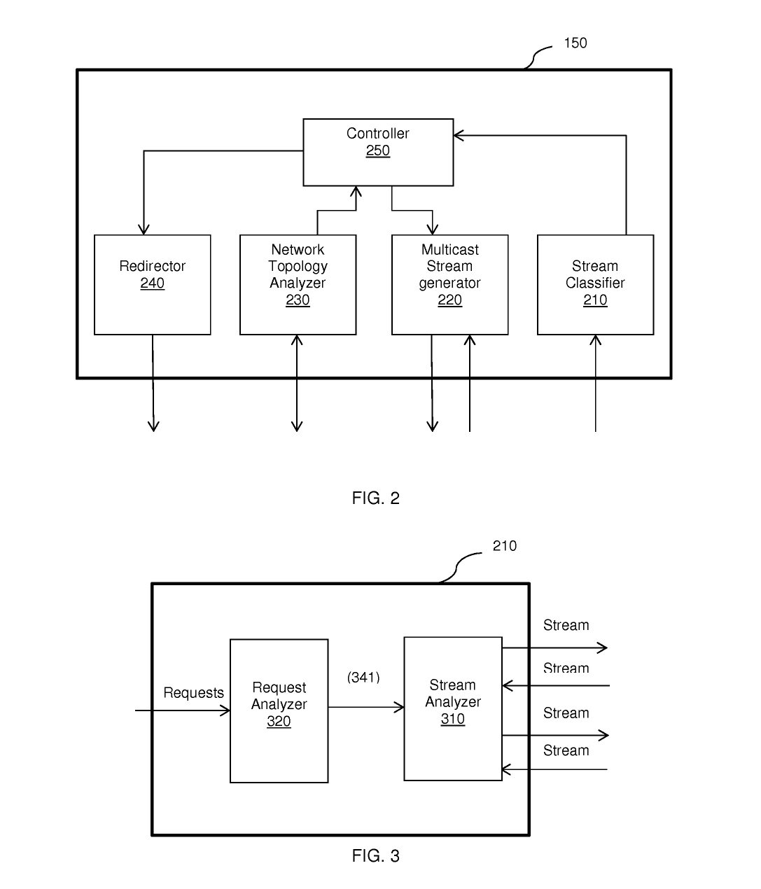

In one embodiment, the MDS 150 is configured to determine the efficiency of multicasting of such detected multicast-able OTT streams. If the MDS 150 determines that the delivery of the live stream in its multicast format would likely improve the performance of the fixed-line network, the MDS 150 converts the live stream from a unicast to a multicast format and delivers the respective multicast OTT stream to its destination, i.e., UEDs (e.g., the UED 110) over the network 120. For example, if a multicast-able OTT stream of a basketball game is currently being watched by 1000 users over their respective UEDs, then the MDS 150 is configured to generate and deliver one multicast OTT stream instead of 1000 unicast OTT streams individually streamed to the UEDs. If the MDS 150 determines that the delivery of the multicast-able OTT stream in its multicast format would likely improve the performance of the fixed-line network, then such stream may be directly delivered to the UED 110. The operation of the MDS 150 is described in more detail with respect to FIG. 2.

According to various exemplary embodiments, a unicast format may include, but is not limited to, a real time messaging protocol (RTMP), a HTTP live streaming (HLS) protocol, or any other streaming protocol over a transmission control protocol (TCP) connection. A multicast format of an OTT stream may include, but is not limited to, real time streaming protocol (RTSP) over user datagram protocol (UDP) or HTTP objects over UDP.

It should be noted that only one UED 110 and one OTT content server 170 are illustrated in FIG. 1 merely for the sake of simplicity of the description. The disclosed techniques can be utilized when multiple UEDs are connected to the MDS 150 and where multiple streams can be streamed from a plurality of OTT content servers.

FIG. 2 is an exemplary and non-limiting block diagram of a MDS 150 implemented according to an embodiment. In some implementations, the MDS 150 includes a stream classifier 210, a multicast stream generator 220, a network topology analyzer 230, a redirector 240, and a controller 250.

The stream classifier 210 monitors traffic flows to and from a fixed-line network (e.g., the network 120) and identifies OTT streams in real-time to detect multicast-able OTT streams. In an embodiment, OTT streams targeted to specific destination IP addresses may be routed to the classifier 210. In another embodiment, the stream classifier 210 may be configured to monitor upstream and downstream links of the fixed-line network using, for example, a deep packet inspection (DPI) element or service chaining element. In this embodiment, the stream classifier 210 may identify requests to OTT streams by extracting or detecting relevant requests for additional processing such as, for example, requests with Port-ID ‘80’ or ‘8080,’ or requests that designate a filename containing the M3U8 prefix.

The stream classifier 210 detects and determines whether an OTT stream requested by the user or provided by the OTT content server is a multicast-able stream. As noted above, a multicast-able stream may include, for example, a live, linear, or replicated OTT stream, or any type of OTT stream that can otherwise be multicasted. In an embodiment, such detection may be performed by comparing OTT streams generated by the same source to identify similarities. In another embodiment, such detection may be implemented by analyzing requests and, upon determining that one or more suspected requests have been identified, retrieving multiple time-shifted copies of the same content and searching for similarities in time.

In an embodiment, the stream classifier 210 is configured to determine the popularity of an OTT stream by analyzing duplicated streams of the same specific content. Duplicated streams can be detected by monitoring requests and responses to such streams. In that embodiment, an OTT stream is determined to be popular if a number of detected corresponding streams exceeds a predefined threshold. A “popular” stream is typically a candidate to be delivered to the UED as a multicast stream.

Referring now to FIG. 3, where an exemplary implementation of the stream classifier 210 is illustrated. The stream classifier 210 includes a request analyzer 320 and a stream analyzer 310. The request analyzer 320 is configured to receive a request for OTT streams from the UED 110 and responses from the OTT content server 170. The request analyzer 320 analyzes the requests and responses to determine if there is a high probability that the requested OTT stream is a multicast-able OTT stream. Such analysis may be in response, but not limited, to a different heuristics to detect suspected requests. The heuristics may be selected based on the streaming protocols utilized by the OTT content server 170.

The stream analyzer 310 is configured to retrieve multiple copies of the requested OTT stream from a server (e.g., the server 170) through a network (e.g., the network 160) and to analyze the retrieved streams. The copies of the streams are typically time shifted. The stream analyzer 310 is configured to search for similar content in the time-shifted streams indicating whether the requested OTT stream is a multicast-able OTT stream. If a stream includes content indicating that the stream is a multicast-able OTT stream, the stream is a suspected stream that is suspected to be a multicast-able OTT stream. In an embodiment, the operation of the stream analyzer 310 is triggered by the request analyzer 320 when a suspected stream is detected.

Upon identification of a suspected multicast-able OTT stream (or any stream that can be multicasted as defined above), an identification of the stream's content is sent to a controller (e.g. the controller 250). An example for such content which may be identified is a uniform resource locator (URL). An example for the operation of the stream classifier 210 can be found in U.S. patent application Ser. No. 14/332,712 filed on Jul. 16, 2014, assigned to the common assignee, and hereby incorporated by reference for all that it contains.

Returning now to FIG. 2, the network topology analyzer 230 is configured to analyze the topology of the fixed-line network 120 and the connectivity of UEDs in such network. According to an exemplary embodiment, the analysis includes determining if elements such as, but not limited to, routers, switches, etc., of the network 120 can support transmission of multicast traffic. In addition, the analysis further determines the topology of connectivity of the UEDs to the fixed-line network 120. Based on the analysis, the network topology analyzer 230 computes a multicast efficiency factor. The multicast efficiency factor may be a number value such as, for example, an integer number from 0 to 10, where ‘10’ indicates high efficiency of the network's 120 resources for delivery of multicast traffic and ‘0’ indicates low efficiency. The multicast efficiency factor is then provided to the controller 250.

Existing networks, such as the fixed-line network 120, currently available the user equipment (e.g., the UED 110) as well as media players installed therein, are conventionally designed to support unicast OTT streams. As a result, such devices do not typically expect to receive streams in multicast format. To this end, the redirector 240 is configured to instruct the UED 110 to expect to receive multicast OTT streams generated by the MDS 150 and to play such streams. In addition, the redirector 240 may configure elements of the fixed-line network to support transmission of multicast content.

The controller 250 is configured to determine, based on the inputs received from the stream classifier 210 and the network topology analyzer 230, whether there is a unicast OTT stream which is currently being delivered in a unicast format that can be transmitted in a multicast format. Such determination may involve consideration of one or more of the following inputs: stream type (e.g., if the stream is a multicast-able OTT stream), a popularity of the requested stream, a value of the multicast efficiency factor, and so on. For example, a request for a multicast-able OTT stream featuring popular content would be delivered in a multicast format to the UED 110 over the network 120 if the efficiency factor is above a preconfigured threshold. It should be noted that, in some implementations, the efficiency factor may not be considered.

If an OTT stream is determined to be delivered in its multicast format, the controller 250 informs the redirector 240 and the multicast stream generator 220 accordingly. In an embodiment, the multicast stream generator 220 is configured to reformat a unicast OTT stream into an OTT stream in a multicast format.

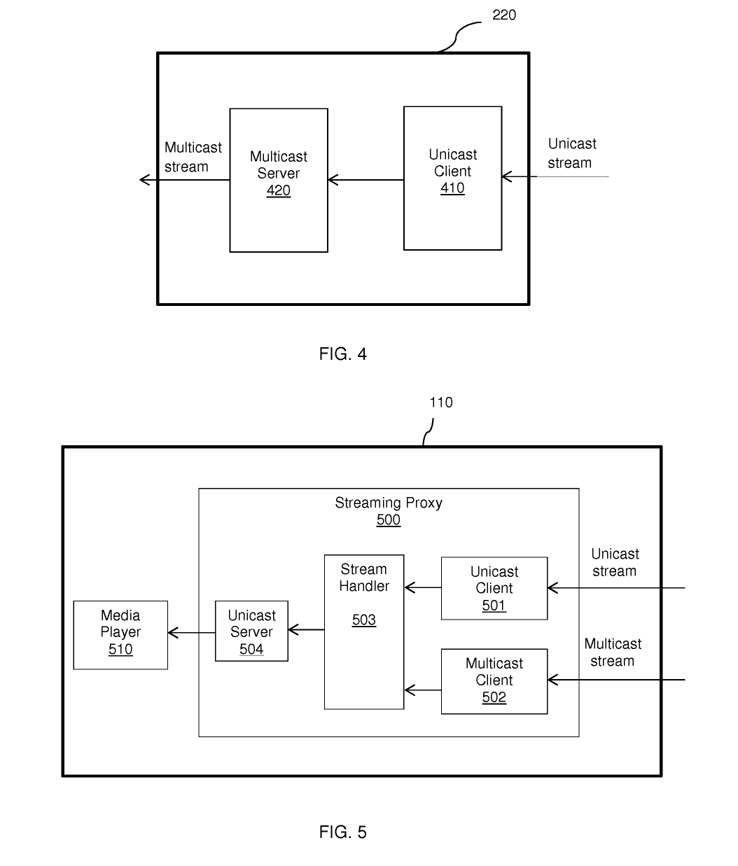

Referring now to FIG. 4, where an exemplary implementation of the multicast stream generator 220 is illustrated. The multicast stream generator 220 includes a unicast client 410 and a multicast server 420. The unicast client 410 is configured to retrieve from the OTT content server 170 of a CDN connected thereto, a multicast-able OTT stream determined to be transmitted in a multicast format. In an embodiment, the retrieval of such multicast-able OTT stream is performed using a content ID such as, e.g., a URL. The unicast client 410 is further configured to terminate the unicast streaming protocol utilized by the OTT content server 170. Such a protocol may be, but is not limited to, a RTMP protocol, and a HSL protocol.

The multicast server 420 is configure to receive the video and audio content of the unicast OTT stream and to convert the stream into a multicast format, thereby generating a multicast OTT stream. The server is further configured to distribute the multicast OTT streams over the fixed-line network 120 using a multicast streaming protocol. The multicast streaming protocol may be, but is not limited to, a RTSP over a UDP protocol or HTTP objects over a UDP protocol.

In an exemplary embodiment, the reformatting of a unicast stream into a multicast stream is performed at two separate layers: an application layer and a transport layer. The processing at the application layer comprises fragmenting a unicast OTT large size transport stream (TS) file into a set of small size (i.e., a having a preconfigured size) TS files. This is performed in order to compensate for the unreliability of a UDP used to transport the multicast traffic. Optionally, reformatting at the transport layer may also be applied by replacing the TCP layer with the UDP layer.

According to various exemplary embodiments, since the delivery of the generated multicast OTT stream is performed over the UDP, which is not a relivable protocol, the multicast server 420 implements one or more of the following content delivery protocols: file delivery over unidirectional transport (FLUTE) and an asynchronous layered coding (ALC). The FLUTE protocol is defined in the RFC 6726 specification published in November 2012, and the ALC is defined in the RFC 5775 specification published in April 10.

Referring back to FIG. 2, in order to allow the relivable delivery of multicast OTT streams, the UED 110 is also configured to implement one of the FLUTE and ALC protocols. The UED 110 is further configured to receive the multicast OTT stream generated by the MDS 150 over a multicast protocol implemented in the MDS 150 and properly streams its content to a media player in the UED 110. In an embodiment, this operation of the UED 110 when handling the multicast stream is enabled by a stream proxy as described in further detail with respect to FIG. 5.

According to another embodiment, the MDS 150 is further configured to optimize the delivery of the managed content (including managed OTT content) streamed by the media server 180. The MDS 150 receives an indication whether the managed content provided by the media server 180 can be transmitted over the fixed-line network in a multicast format. If so, the MDS 150 reformats the managed content from unicast format to multicast format and instructs the UED 110 as discussed in detailed above.

In certain implementations, the MDS 150 also comprises one or more network interfaces to interface with one or more networks (e.g., fixed-line network 120 and communication network 160), one or more processing systems, and a memory, the memory containing instructions to be executed by the processing system.

In some implementations, each of the live stream classifier 210, the multicast stream generator 220, the network topology analyzer 230, the redirector 240, and the controller 250 may be realized by a processing system. The processing system may comprise or be a component of a larger processing system implemented with one or more processors. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

FIG. 5 shows a block diagram of the UED 110 equipped with a streaming proxy 500 and a media player 510. A media player 510 is operable in the UED 110 and configured to play over-the-top (OTT) content streams from an OTT content server. The media player 110 may be a standalone application or executed from a web-browser, an application (e.g., a mobile app), and the like. The media player 510 may not support multicast streaming. Thus, the proxy 500 is configured to adapt a received multicast stream to a unicast format.

The streaming proxy 500 includes a unicast client 501, a multicast client 502, a stream handler 503, and a unicast server 504. The unicast and multicast clients 501 and 502, respectively, implement unicast and multicast protocols, respectively, such as those mentioned above.

The unicast client 501 is connected to a unicast stream source such as the OTT content server 170, and the multicast client 502 is connected to the MDS 150. The stream handler 503 is configured to select the proper source (i.e., unicast or multicast) from the stream to the media player 510 that should be delivered. The stream handler 503 is also configured to convert the stream from its multicast format to a unicast format when the multicast source is selected. That is, in order to maintain transparency for the media player 510, an OTT stream received in a multicast format (e.g., RTSP over User Datagram Protocol (UDP) or hypertext markup language (HTML) object over UDP) may be reformatted into a unicast format supported by the media player 510 (e.g., a RTMP over TCP or HLS over TCP format).

The unicast server 504 receives a stream's content in a unicast format from the handler 503 and streams the content to the media player 510. The unicast server 504 can implement any of the unicast streaming protocols noted above.

In some embodiments, the streaming proxy 500 is further configured to switchover from a selected source to another source such as, e.g., from a unicast to multicast streaming source, or vice-versa. The switchover decision may be taken based on various parameters. In one embodiment, the switchover may be required if, for example, the number of users attempting to access the OTT content increases such that switching from several unicast streams to one multicast stream would decrease bandwidth and improve user experience. In such cases, the streaming proxy may be configured to temporarily retrieve both the multicast and unicast streams, thereby enabling the stream to continue uninterrupted as the UED 110 transitions from providing a unicast stream to providing a multicast stream.

It should be noted that the switching from one source to the other is performed without stopping, delaying, or impacting the reception of a stream played by the media player 510. That is, from the viewer's perspective, the transition to a different OTT streaming source is seamless and would not impact the QoE provided to a viewer of the media player 510.

In certain implementations, the streaming proxy 500 may be implemented in an external system communicatively connected to the UED 110. In one implementation, a streaming proxy 500 may be realized as a virtual machine executed in such an external system. Accordingly, an instance of a streaming proxy 500 is created for each user terminal. An example for the operation of the streaming proxy 500 can be found in U.S. patent application Ser. No. 14/339,035 filed on Jul. 23, 2014, assigned to the common assignee, and hereby incorporated by reference for all that it contains.

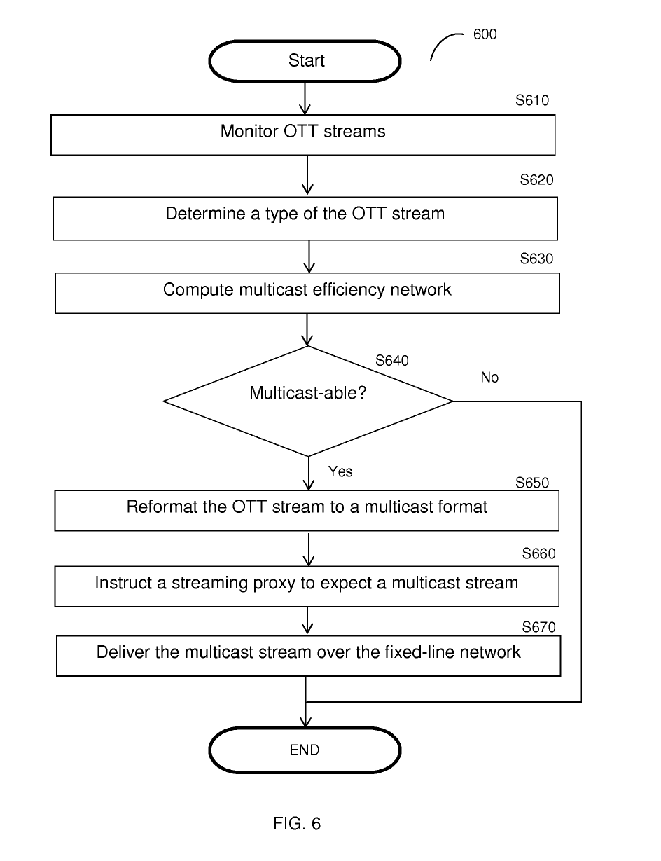

FIG. 6 is an exemplary and non-limiting flowchart 600 illustrating the operation of the MDS 150 according to one embodiment. At S610, OTT content streams flow to and from a fixed-line network are monitored. In one embodiment, such streams can be forwarded by a deep packet inspection (DPI) element, a service chaining element, or a routing network element. The forwarding decision by any of these elements is based on a set of rules such as, but not limited to, a destination IP address designated in the request. The destination IP address may be, for example, an IP address of an OTT content server.

At S620, a type of the OTT stream is determined. In an embodiment, such a determination may include if a type of a requested or otherwise delivered stream can be transmitted in a multicast format, that is, if the stream is a multicast-able OTT stream. In various embodiments, streams (multicast-able streams) which are suitable for multicast streaming include, but are not limited to, live, linear, and replicated streams, as well as any other streams which may be multicasted.

In yet another embodiment, the determination of type of stream may further include determining a popularity of the requested stream. In an exemplary embodiment, this includes checking if the number of duplicated OTT streams detected during a predefined time interval to a specific OTT stream exceeds a predefined threshold. In such an embodiment, if the number of such duplicated streams exceeds the threshold, the stream is determined to be popular. In various embodiments, popular streams may be suitable for delivery to a UED as multicast streams. As a non-limiting example, if it is determined that one or more duplicated streams (i.e., OTT streams to the same content) have been detected during a period of 10 seconds, the stream is determined to be popular.

At S630, the multicast network efficiency is computed. This computation may be based on, but is not limited to, information related to the availability of multicast resources of the fixed-line network, the topology of the fixed-line network, and connectivity of UEDs to the fixed-line network.

At S640, it is determined whether the requested or otherwise delivered OTT stream requires multicasting. That is, if multicasting an OTT stream detected at S620 would improve the efficiency of the fixed-line network; and the overall performance of the OTT streaming services. The determination is based in part on the type of each monitored OTT stream, popularity of each monitored OTT stream and/or the computed multicast streaming factor. If so, execution continues with S650; otherwise, execution terminates.

At S650, a monitored OTT stream determined to require multicasting is reformatted from a unicast into a multicast format. As a non-limiting example, a stream may be converted from a HLS over TCP format to a HTTP objects over a UDP format. In an embodiment, reformatting of a unicast stream into a multicast stream may be performed at two separate layers, an application layer and a transport layer. The conversion, in an exemplary embodiment, includes fragmenting a unicast OTT stream into a set of small (i.e., having a preconfigured size) transport stream (TS) segments.

At S660, a streaming proxy (e.g., the streaming proxy 500) is instructed to expect a multicast OTT stream from the MDS 150. In another embodiment, S660 may include configuring elements of the fixed-line network to support transmission of multicast content. At S670, the multicast stream is delivered over a fixed-line network.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

Also, it should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

Although some benefits and advantages of the preferred embodiments are mentioned, the scope of the disclosure is not intended to be limited to particular benefits, uses, or objectives. Rather, embodiments of the disclosure are intended to be broadly applicable to different wireless technologies, system configurations, networks, and transmission protocols, some of which are illustrated by way of example in the figures and in the description.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for delivery of over-the-top (OTT) streams over a fixed-line network, comprising:
monitoring OTT streams flow in the fixed-line network;
determining if the delivery of at least one of the monitored OTT streams improves the efficiency of the fixed-line network when the at least one of the OTT streams is delivered in a multicast format;
reformatting the at least one of the OTT streams into a multicast OTT stream;
instructing user edge devices connected to the fixed-line network to expect the reception of the multicast OTT stream; and
delivering the multicast OTT stream to the user edge devices over the fixed-line network.

2. The method of claim 1, further comprising:
computing a multicast network efficiency factor indicating the efficiency of delivery of an OTT stream in a multicast format over the fixed-line network.

3. The method of claim 2, wherein determining if the delivery of the at least one of the monitored OTT streams in a multicast format improves the efficiency of the fixed-line network further comprising:
determining whether the at least one of the OTT streams is a multicast-able OTT stream.

4. The method of claim 3, wherein the multicast-able OTT stream is any one of: a live OTT stream, a linear OTT stream, and a replicated OTT stream.

5. The method of claim 3, further comprising:
determining a popularity of the at least one of the OTT streams.

6. The method of claim 5, wherein the at least one of the OTT streams is determined to be popular when a number of requests to the at least one of the OTT streams exceeds a predefined threshold.

7. The method of claim 5, wherein determining if the at least one of the OTT streams improves the efficiency is based on at least one of: the type of the at least one of the OTT streams, the popularity of the at least one OTT stream, and a value of the multicast efficiency factor.

8. The method of claim 1, wherein reformatting the at least one of the OTT streams into a multicast OTT stream is performed on at least one of: an application layer, and a transport layer.

9. The method of claim 1, wherein the fixed-line network includes at least one of: a cable network, a fiber optic network, a wireless local area network, and a digital subscriber line (DSL) network.

10. A non-transitory computer readable medium having stored thereon instructions for causing one or more processing units to execute the method according to claim 1.

11. A system for delivery of over-the-top (OTT) streams in a fixed-line network, comprising:
a processing unit; and
a memory, the memory containing instructions that, when executed by the processing unit, configure the system to:
monitor OTT streams flow in the fixed-line network;
determine if the delivery of at least one of the monitored OTT streams improves the efficiency of the fixed-line network when the at least one of the OTT streams is delivered in a multicast format;
reformat the at least one of OTT streams into a multicast OTT stream;
instruct user edge devices connected to the fixed-line network to expect the reception of the multicast OTT stream; and
deliver the multicast OTT stream to the user edge devices over the fixed-line network.

12. The system of claim 11, wherein the system is further configured to:
compute a multicast network efficiency factor indicating the efficiency of delivery of an OTT stream in a multicast format over the fixed-line network.

13. The system of claim 11, wherein the system is further configured to:
determine whether the at least one of the OTT streams is a multicast-able OTT stream.

14. The system of claim 13, wherein the multicast-able OTT stream is any one of: a live OTT stream, a linear OTT stream, and a replicated OTT stream.

15. The system of claim 13, the system is further configured to:
determine a popularity of the at least one of the OTT streams.

16. The system of claim 15, wherein the at least one of the OTT streams is determined to be popular when a number of requests to the at least one of the OTT streams exceeds a predefined threshold.

17. The system of claim 15, wherein determining whether the at least one of the OTT streams improves the efficiency of the network is based on at least one of: the type of the at least one OTT stream, the popularity of the at least one of OTT streams, and a value of the multicast efficiency factor.

18. The system of claim 11, wherein the system is further configured to reformat the at least one OTT stream into a multicast OTT stream on at least one of: an application layer, and a transport layer.

19. The system of claim 11, wherein the fixed-line network includes at least one of: a cable network, a fiber optic network, a wireless local area network, and a digital subscriber line (DSL) network.

20. A method for delivery of managed multimedia content in a fixed-line network, comprising:
receiving an indication that a managed content can be delivered in a multicast format;
reformatting the managed content from a unicast format to a multicast format; and
instructing user edge devices connected to the fixed-line network to expect the reception of the managed content in a multicast format.
